(19) United States
(12) Patent Application Publication
(10) Pub. No.: US 2008/0156350 A1
(43) Pub. Date: Jul. 3, 2008

(54) Device and Method

(75) Inventors: Louise Margaret Barlow, Hull (GB); Victoria H. Cobb, Hull (GB); Coreen Iliffe, Montvale, NJ (US); Jonathan Mark Law, Hull (GB)

Correspondence Address: NORRIS, MCLAUGHLIN & MARCUS, 875 THIRD AVE, 18TH FLOOR, NEW YORK, NY, 10022, US

(73) Assignee: Reckitt Benckiser (UK) Limited, Slough (Berkshire) (GB)

(21) Appl. No.: 11/912,010

(22) PCT Filed: Apr. 20, 2006
(86) PCT No.: PCT/GB06/01439

§ 371 Date: Nov. 13, 2007

(30) Foreign Application Priority Data
Apr. 21, 2005 (EP) 05008726.1

(51) Int. Cl. D06B 1/08; B08B 7/00; B08B 3/04

(52) U.S. Cl. 134/4; 134/95.1; 8/148

(57) ABSTRACT

A device for treating a surface to give a cleaning benefit comprises a container (302) containing a cleaning liquid. The liquid can be delivered to an outlet zone (306). By virtue of the outlet zone and a separate defining means (322) which may be provided the cleaning liquid is accurately discharged onto the desired area of the surface. Suitably the cleaning liquid forms a gel patch, which can be peeled away, to remove a stain.

The present invention relates to a device for applying a treatment agent to a surface, particularly to a textile surface, to remove stains; and to an associated method.

WO 02/102957 (to Reckitt Benckiser (UK) Limited) discloses textile treatment compositions comprising a patch with a water-impervious backing made of a polymer sheet to which is attached a hydrogel containing a surfactant treatment fluid.

The present invention concerns the delivery of agents to treat a surface, for example to form a stain-removing gel on the surface.

In accordance with a first aspect of the present invention there is provided an apparatus for treating a surface, the apparatus comprising a device for delivery of a treatment agent to the surface and defining means which is adapted for engagement with the surface, and which delimits the area of the surface which is thus treated.

The defining means may be integral with the device or may be provided separately. When provided separately, the device may be provided with a means of storing or retaining the defining means.

The defining means comprises a wall or barrier which is placed, in use, on to the surface. It thus functions as a frame or mask, retaining the agent within the barrier so that it does not extend beyond the area of the surface which needs to be treated. In this way, treatment agent is not wasted, which has obvious cost and environmental benefits.

The agent may be provided as a solid, a liquid or a gel. Preferably it is a liquid, more preferably an aqueous liquid. By liquid herein is meant that a flowable material having a viscosity of 100,000 mPa·s or less at a shear rate of 1 s⁻¹ at 25° C.

Preferably following delivery to the surface, the agent undergoes a physical or chemical change. This may be a decomposition or oxidation reaction induced by exposure to air, for example. Preferably however the agent undergoes a change of state and/or an increase in viscosity. This may be induced by a chemical or physical change which occurs upon exposure to air, or could be due, for example to evaporation of a volatile component. Preferably following delivery to the surface, the agent forms a gel within the defining means.

The device preferably further comprises actuator means to control delivery of the treatment agent to the surface.

In preferred embodiments, the apparatus comprises a first chamber containing a first agent and a second chamber containing a second agent, wherein the defining means delimits the same area for both agents.

The first agent could be delivered from a first outlet provided on the first chamber and the second agent could be delivered from a second separate outlet provided on the second chamber. Alternatively, the device could be provided with a common outlet zone from which the first and second agents can be delivered.

The provision of a common outlet zone is preferred as this allows the first and second agents to be delivered to a single locus without the need to alter the position of the device.

When the device is provided with a common outlet zone, the defining means may be integral with the device.

In such an embodiment, the defining means is provided at the terminus of the common outlet zone. The terminus of the common outlet zone is the part through which the agents exit the device; it is the end opposite to where the chambers housing the agents are located. The terminus of the common outlet zone may thus be provided with a boundary wall or barrier which comprises the defining means.

When the device comprises two agents, the actuator means is preferably adapted to deliver the second agent only when the delivery of the first agent has ended.

The actuator means could comprise a first actuator for discharging the first agent and a second actuator for discharging the second agent. However in preferred embodiments of the invention there is a common actuator. For example a common actuator may be pressed and thereby expel the first agent, and subsequently the second agent. This may happen, when the agents are liquids, by sequential action of pistons which are displaced from each other, the first piston expelling the first liquid and the second piston subsequently expelling the second liquid.

In other embodiments a common actuator may be a rotary actuator which allows the first and second agent to be delivered in a sequential manner when turned.

Where the defining means is provided separately from the device, the two agents could in one embodiment be delivered from respective ends of device whereby the actuator means is opened by squeezing the device either at a general central location or at two different locations. The device may, for example, be generally tubular.

The device could also make a third delivery of an agent, to the area of surface to be treated. That delivery could be of a third agent or could be a further delivery of the first or second agent. Preferably when there is a third delivery it is of the first agent.

Preferably the first and, when present, second outlet(s) or the common outlet zone is/are covered by a closure, for storage purposes. The closure is removed when the device is to be used. Preferably the closure is attached to the device, for example by a hinge or web.

Preferably the actuator means is adapted to deliver a predetermined quantity of the first agent.

Preferably the actuator means is adapted to deliver a predetermined quantity of the second agent, when present.

When there is a single or common outlet zone for delivery of two agents, the actuator means is preferably aligned with the single or common outlet zone. Preferably the actuator is on one side of the device and the single or common outlet zone on the other side of the device. It is beneficial that a downward force applied to the actuator means during its operation is conveyed to the single or common outlet zone in such a way as to minimise torque and/or allow for the possibility in certain preferred embodiments, of one-handed operation.

When two agents are present, the actuator means is preferably such as to apply a force to the material formed by mixing the first and second agents, against the surface.

In preferred embodiments, the first and second agents could both be solids, for example particulates which on coming together form a liquid or gel.

Alternatively the first agent could be a solid and the second agent a liquid or gel, the first agent liquefying or dissolving or forming a gel when contacted by the second agent.

The first and second agents may both be gels.

Preferably, however, at least one of the first and second agents is a liquid, preferably an aqueous liquid.

Most preferably the first and second agents are both liquids, and most preferably aqueous liquids.

The specification will now for convenience and ease of reading use the word liquids, but the definitions given also apply to other first and, when present, second agent(s), unless the context prevents it. Also, it should be kept in mind that the present invention may be used when only one treatment agent is delivered to the surface. The definitions herein may also be applied to such an embodiment, unless the context prevents it.

In preferred embodiments comprising two agents, the first and second liquids are preferably such that, on coming together, they undergo a change of state and/or an increase in viscosity. Preferably they form a solid or gel, most preferably a hydrogel (hereinafter collectively called a “patch”). Preferably the patch is sufficiently strong that it can be peeled from the surface. The provision of liquids may facilitate good wetting of the surface, whilst the resulting material of increased viscosity allows the patch to be removed from the surface. When it is used, as is preferred, for cleaning a stain, the stain is preferably removed along with the patch.

Preferably the first liquid is of viscosity in the range of from 1 to 1,000 mPa·s, preferably of from 1 to 100 mPa·s, at a shear rate of 1 s⁻¹ at 25° C.

Preferably the second liquid is of viscosity in the range of from 1 to 20,000 mPa·s, more preferably of from 1,000 to 15,000 mPa·s, most preferably of from 5,000 to 10,000 mPa·s, at a shear rate of 1 s⁻¹ at 25° C.

A patch as described may also be formed following the delivery of a single agent to a surface. In this case a change of state may be induced by, for example, exposure to air.

The dimensions of the patch are determined by the defining means. The defining means is suitably left on the surface until the patch has developed.

The defining means may then be removed to leave a patch which can be peeled off by the user.

Alternatively, the defining means may be used to aid the removal of the patch. The patch may become adhered to the walls of the defining means.

Preferably the area limited by the defining means is at least 4 cm², more preferably at least 6 cm². Preferably the area does not exceed 40 cm², and preferably does not exceed 30 cm².

Preferably the defining means is circular, preferably of diameter in the range of from 2 to 8 cm, more preferably of from 3 to 6 cm.

The defining means preferably comprises an annular wall or body made from a plastics material, for example a polyalkylene, but defining means having other shapes are not excluded.

Preferably the defining means is not more than 3 mm thick, more preferably not more than 2 mm thick, and most preferably not more than 1 mm thick.

Preferably the defining means is flexible, so as to aid removal of a patch by a progressive action, for example a peeling action.

Suitable materials for the defining means include card, plastics sheet materials (e.g. films) and fabrics.

Where the defining means is provided separately from the device, the outlets or common outlet zone of the device preferably is/are slightly larger than the opening of the defining means. During delivery, the device is in contact with the upper face of the defining means. The patch may thereby have an outer rim in contact with the upper face of the defining means, around its opening. This additional contact with the defining means may aid removal of the patch from the material.

Optionally, the defining means may comprise support elements, e.g. strands or threads, which extend across the opening in the defining means. These support elements are preferably aligned with each other. There may additionally be further support elements transverse to these, to form a net-type or mesh structure. When the patch forms, for example during the transformation of two liquids into a gel, such support elements become embodied within the patch. This supports the patch and enables it to be removed from the surface more easily. Such support elements may be provided on a defining means which is independent from the device or may be provided across the terminus of a common outlet zone, where this is the defining means.

By “surface”, we include both hard and soft surfaces. By “hard surface”, we include ceramics, glass, stone, plastics, marble, metal and/or wood surfaces, such as, in the household environment for example, bathroom and kitchen hard surfaces such as sinks, bowls, toilets, panels, tiles, worktops, dishes, and the like. Hard surfaces are non-porous to water, by which it is meant that a hard surface, on contact with water for 5 minutes, takes up less than 5 mg of water per cm². By “soft surface”, we include textiles, clothing, carpets, curtains, upholstery, textile or fabric covered articles, and the like. Soft surfaces are porous to water, by which it is meant that a hard surface, on contact with water for 5 minutes, takes up 5 mg or of water per cm².

Preferably the surface is a textile surface, and the device is to be used for removing stains therefrom. Preferably at least the first liquid is able to achieve good wetting of its fibres, and preferably penetrate the textile surface. In one embodiment in which a second liquid is provided this is of higher viscosity, so that it does not penetrate the textile surface and wet its fibres to the same degree. Rather, it sits as a layer on the textile surface. Nevertheless it mixes with the first liquid and the liquids preferably form a patch of higher viscosity than either of the first or second liquids.

Preferably there are two agents, the first of which is a hydrogel-precursor and the second of which is a cross-linking agent. The paragraphs which follow relate to such preferred embodiments.

The cross-linking agent and hydrogel-precursor may be applied sequentially in either order: cross-linking agent first or hydrogel-precursor agent first. However it is preferred that the first agent applied to the surface is the cross-linking agent and the second agent applied is the hydrogel-precursor.

In some embodiments a third application may be made, preferably a repeat application of the first agent applied.

In such embodiments the cross-linking agent cross-links the hydrogel-precursor polymeric material of the hydrogel-precursor as part of the patch-forming process, leading to the formation of a hydrogel patch. Therefore, a requirement for this cross-linking agent is that it comprises a species capable of cross-linking the other agent (preferably polymer material of the other agent) as part of the patch-forming process.

By the term “hydrogel” as used herein it is meant a natural or synthetic polymeric material which possesses the ability to swell in water. The hydrogel may be water-insoluble or water-soluble; preferably it has a solubility in water of less than 1 g/dm³. By “hydrogel-precursor” is meant a material which can be cross-linked in order to form a hydrogel. Natural hydrogel precursors are suitable for the invention, such as alginates and other polysaccharides with free carboxylic acid groups.

Suitably, the hydrogel-precursor is a hydrophilic homopolymer or copolymer of acrylic or methacrylic acid, or a salt thereof; or a carboxylated cellulose derivative.

The polymer, once formed into a hydrogel, is cross-linked to a relatively low degree and but for the cross-linking would be essentially water-soluble.

The polymer may include in its structure a polysaccharide such as starch, for example in a graft copolymer.

Where the hydrogel-precursor comprises free carboxylate groups as described above, the cross-linking component suitably comprises metal M²⁺ ions (where M is a Group IIA element or any other metallic element capable of exhibiting a +2 oxidation state), more preferably wherein M is a Group IIA element, even more preferably Ca²⁺ ions, i.e. this liquid component comprises an M²⁺ salt, e.g. a calcium salt. Yet more preferably, this liquid component comprises calcium chloride as the source of Ca²⁺ ions.

In another embodiment, the hydrogel-precursor may be carrageenen, preferably iota-carrageenan, or pectin. For these materials, calcium ions are suitable cross-linking agents. Another suitable hydrogel-precursor is chitosan, which is soluble in acidic or protonated form, and gels in the presence of alkali. If the hydrogel-precursor component comprises chitosan, the cross-linking agent should comprise an alkali, preferably sodium hydroxide.

More preferably, the hydrogel-precursor comprises alginic acid or an alginate, where an alginate is a salt of alginic acid, even more preferably, a sodium alginate. Hereinafter, the term “alginate” is used to refer to either alginic acid or a water-soluble salt thereof, such as a sodium salt.

Alginic acid or alginates may be found in and isolated from various organisms, in particular from algae belonging to the order Phaeophyceae and soil bacteria such as Azotobacter vinelandii and Azotobacter crococcum and from several strains of Pseudomonas bacteria. Common algal sources of algins include Laminaria digitata, Ecklonia maxima, Macrocystis pyrifera, Lessonia nigrescens, Ascophyllum nodosum, Laminaria japonica, Durvillea antartica, Durvillea potatorum and, especially, Laminaria hyperborea.

Alginic acid is a linear hetero-polysaccharide comprising units of β-D-mannuronic acid and α-L-guluronic acid. Alginic acid may comprise homopolymeric sequences of mannuronic acid, homopolymeric sequences of guluronic acid, and mixed sequences of mannuronic acid and guluronic acid units.

Salts of alginic acid used in the method of the present invention may include alkali metal salts, for example sodium and potassium salts, and ammonium and alkanolamine salts. Alkali metal salts are of particular interest.

The terms “algins” or “alginates” as used herein include alginic acid and salts of alginic acid, irrespective of the relative proportion of mannuronic and guluronic units, and is intended to include glycolated or alkoxylated derivatives, especially those derivatised with propylene glycol. However, preferred compounds are not alkoxylated or glycolated. Guluronic acid-rich alginic acid and guluronic acid-rich salts of alginic acid are of particular interest, as they are found to improve the mechanical properties of the patch thus formed and hence the ease with which it can be removed. Preferably the alginate should have a guluronic (G-block) content of at least 15% of the total alginate weight, more preferably at least 25%, more preferably at least 35%. More preferred alginates have at least 50%, more preferably 55-99%, most preferably 60-80% of guluronic units (by weight of the alginate), the balance being mannuronic units. For guidance on production of algins very high in guluronic units the reader is referred to WO 98/51710.

Suitable alginates for use in the method of the present invention include those in the Protanal range, LF20, GP6650, and XP3499 (Trade Marks; products all available from FMC BioPolymer of Philadelphia, Pa. 19103, USA).

Protanal LF20 is preferred and is a sodium alginate. Preferably, the agent containing the hydrogel-precursor (preferably an alginate), comprises the hydrogel-precursor in the range 0.1 to 10 wt % compared to the overall weight of that agent, more preferably in the range 0.25 to 5 wt %, most preferably 0.4 to 4 wt %, for example 0.5 wt % to 3 wt %.

Without wishing to be bound by theory, alginates are, as noted hereinbefore, comprised of mannuronate and guluronate monomers and in order to form a gel, and thus a usable patch in the method of the present invention, the alginate should contain a sufficient level of guluronate monomers in a block to react with metal cations, such as divalent ions (preferably calcium ions) from the other component(s) to form a gel. It is believed that the metal ions essentially “fit” into the guluronate block structure in suitable alginates.

Preferably, therefore, the cross-linking agent comprises metal cations, preferably M²⁺ cations, most preferably Ca²⁺, cations in the range 0.03 to 5 wt %, more preferably in the range 0.05 to 4 wt %, even more preferably in the range 0.1 to 3 wt %, most preferably in the range 0.2 to 2 wt % (weight of metal cations/cross-linking agent).

When the metal ion is provided by calcium chloride, the preferred weight percentage expressed as weight percent of CaCl₂.2H₂O in the cross-linking component is 0.1, to 10 wt % of the overall weight of this component, more preferably 0.5 to 3.5 wt %, even more preferably 0.5 to 3.0 wt %, most preferably 0.8 to 2 wt %.

Most preferably, the first agent applied comprises calcium chloride solution, and the second agent applied comprises a soluble alginate salt, preferably sodium alginate. A further application of calcium chloride solution may then be made, if wished.

In further embodiments of the invention further components can be in any agent used in the invention. Examples of such components are described below, and may improve still further the effectiveness of embodiments of the invention.

For the avoidance of doubt, any one or more of these components can be added to the first and, when present, second agents as set out hereinafter, or to the third agent when used, in any mutually compatible manner, unless stated otherwise or when their formulations together would decrease the efficacy of one of them, or otherwise be detrimental.

A yet further advantage of the present invention is that because the at least two agents are kept separate until the user uses the device, it is possible for mutually incompatible or antagonistic further components to be employed.

Optional further compounds may include one or more of the following.

### Silicones

A silicone may comprise a silicone oil, preferably a cyclic or linear polydimethylsiloxane preferably having a viscosity at 25° C. and at a shear rate of 1 s⁻¹ of from 10 to 10,000 mPa·s.

Such silicone oil is suitably in the form of emulsified droplets, preferably in the hydrogel-precursor component of the invention. A suitable level is from 0.1 to 2 wt %, preferably from 0.5 to 1.5 wt % by weight of the patch formed in the method. Suitable surfactants for use in emulsification may be as described below. Alternatively, a silicone-based surfactant may be used.

An advantage of the presence of the silicone oil is that it may provide improved peelability for a patch.

### Anti-Limescale Agents

Examples of anti-limescale agents include acids, particularly organic acids (e.g. citric acid), and anti-nucleating polymers, such as polyacrylates. Other relevant acids that may be present include glycolic and sulphamic acids. Preferably, the amount of acid present for limescale removal is sufficient to provide a pH of 1-7, more preferably 2-7, most preferably 3-6, at the treatment site.

### Bleach

Peroxygen bleaching agents may be present in some embodiments (in particular non-aerosol embodiments). Suitable peroxygen bleaching compounds include sodium carbonate peroxyhydrate and equivalent “percarbonate” bleaches, sodium pyrophosphate peroxyhydrate, urea peroxyhydrate, and sodium peroxide. Persulfate bleach (e.g. OXONE (Trade Mark; manufactured commercially by DuPont) can also be used. Perestane or PAP are also suitable bleaches for use with the invention.

Bleach activators can also be present. Bleach activators lead to the in situ production in aqueous solution of the peroxy acid corresponding to the bleach activator. Various non-limiting examples of activators are disclosed in U.S. Pat. No. 4,915,854, issued Apr. 10, 1990 to Mao et al, and U.S. Pat. No. 4,412,934. The nonanoyloxybenzene sulfonate (NOBS) and tetraacetylethylene diamine (TAED) activators are typical and are preferred, and mixtures thereof can also be used. See also U.S. Pat. No. 4,634,551 for other typical bleaches and activators useful herein.

The bleach system, if present, may suitably be in a said cross-linking component.

More preferably, the bleach system is contained in the component containing a said hydrogel-precursor. It has been found that this gives improved stain removal from soft surfaces compared to that achieved when the bleach is in with the other component.

The bleach when present is at a level in the range 0 to 8 wt %, more preferably 1 to 7 wt %, most preferably in the range 2 to 6 wt %, of the agent in which it is provided.

In embodiments of the invention where a peroxide or peroxide generator is used as a bleach system, it is preferred if the peroxide- or peroxide generator is present in the hydrogel-precursor component at a pH from 4 to 6, preferably 4.5 to 5.5. At lower pH the precursor may be unstable. At higher pH the peroxide may dissociate on storage.

In such embodiments, it is preferred if the pH of the other, cross-linking component is 8 to 10, preferably 8.5 to 9.5. This helps to increase the effectiveness of the peroxide for bleaching when the components are mixed. If the pH of the metal ion-containing agent is too high, the ions may precipitate from solution, especially where Ca²⁺ ions are present.

### Enzymes

Enzymes can be included in the agents herein for a wide variety of fabric laundering purposes, including removal of protein-based, carbohydrate-based, or triglyceride-based stains, for example, and for the prevention of dye transfer, and for fabric restoration. The enzymes to be incorporated include proteases, amylases, lipases, cellulases, and peroxidases, as well as mixtures thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, builders and so on. In this respect bacterial or fungal enzymes are preferred, such as bacterial amylases and proteases, and fungal cellulases.

Preferably, enzymes if present, are in the first or second agent at a level in the range 0.001 to 5 wt %, more preferably 0.01 to 1 wt %, of the agent.

### Solvent

Solvents; particularly organic solvents, may be present in the first and/or second agent. More preferably, organic solvents, such as glycol ethers, C₁-C₁₀ alcohols, C₁-C₁₀ hydrocarbons or halohydrocarbons, carbonyl-based solvents such as acetone, and the like, are present, preferably in the component(s) comprising M²⁺ ions. The organic solvent, if present, should preferably be included in an amount from 5 to 50 wt % of the component. The overall levels of organic solvents should be within the VOC limits of cleaning products and preferably, the maximum level of organic solvent in either or both agent is 8 wt %, more preferably, up to 6 wt %, most preferably up to 4 wt %.

### Surfactant

Non-limiting examples of surfactants useful herein comprise anionic surfactants such as sarcosides, C₁₀-C₂₀ alkyl benzene sulfonates, C₁₀-C₂₀ alkyl sulfates and ether sulfates or/and nonionic surfactants such as ethoxylated and/or propoxylated fatty acid esters or alcohols.

Mixtures of anionic and nonionic surfactants are especially useful. Other conventional useful anionic, amphoteric, nonionic or cationic surfactants are listed in standard texts.

Preferably, the surfactant is sodium lauryl sarcosinate, available in 30% form as SURFAC SL3OF (Trade Mark; available from Surfachem Plc, Leeds, UK), and/or sodium lauryl sulfate.

Preferably, surfactant(s) if present, is/are in the first and/or second agent, at a level in the range 0.01 to 50 wt %, more preferably 0.05 to 20 wt %, most preferably 0.1 to 10 wt %, for example 4 wt %, of the agent.

Anionic surfactants are preferred over nonionic or zwitterionic surfactants, in that they give improved peelability of a patch.

Preferably at least one of the agents used in the present invention comprises at least one surfactant.

### Sequestrant

Sequestrants, such as Dequest 2066 (Trade Mark; product available from Solutia Inc., St Louis 6366-6760, USA), EDTA, and Dissolvine EDG (Trade Mark; product available from Akzo Nobel, Gillingham, UK), aid in stain removal and hence are preferably present in one or more of the agents used in the present invention, more preferably in a hydrogel-precursor.

The overall level of sequestrant present should be within permitted phosphorus regulations, if relevant. Hence, the upper limit to be used is specific to the particular sequestrant. Thus, for Dequest 2066, the amount present is preferably up to 1.5 wt %, more preferably up to 1 wt %, most preferably up to 0.8 wt %, for example 0.8 wt % of the agent. Where permitted phosphorus regulations are not relevant, the sequestrant may be present up to 20 wt %, more preferably 15 wt %, of the agent. Preferably, the sequestrant is present in any hydrogel-precursor agent.

Particularly preferred sequestrants for use with the invention are iminodisuccinic acid or its salts and/or DTPA (diethylene triamine pentaacetic acid).

### Glycerol

Glycerol is found to improve the integrity and hence the peelability and thus removability of a patch formed using the device of the present invention. This is particularly so when the glycerol is in a hydrogel-precursor, as one of the agents.

Glycerol may be present at between 0 and 50 wt % of an agent. When present it is preferably found at 2 to 25 wt %, more preferably 4 to 20 wt %, most preferably 6 to 15 wt %, of that agent.

### Further Components

The agents of the invention are preferably made up to 100 wt % by water, preferably de-ionised water, typically at levels of 5 to 99 wt % water.

Either or both agent may further comprise additional cleaning agents, such as monoethanolamine and triethanolamine, at levels in the range 5-20 wt %, more preferably 5-15 wt %, most preferably 5 to 10 wt %, of the respective component.

Either or both agents may further comprise a fragrance. Preferably a fragrance in either agent is at a level in the range of 0.1 to 5 wt %, more preferably 0.2 to 4 wt %, most preferably 0.5 to 3 wt %, of the weight of the agent.

Dyes can also be added to either or both agent to make a coloured patch.

Either or both agents may further comprise additional ingredients, such as antimicrobials (e.g. quaternary ammonium compounds, triclosan, and other phenolic agents such as para-chloro meta xylenol (PCMX), citric acid, lactic acid) and if present, are preferably present in the range of 0.01 to 5 wt % of the agent, more preferably in the range 0.02 to 3 wt %, e.g. at 1 wt % (especially for triclosan); preservatives, e.g. methylparaben, ethylparaben, propylparaben, or mixtures thereof (if present, preferably present in the range of 0.01 to 0.5 wt % of the agent, more preferably in the range 0.01 to 0.2 wt %); or film formers such as polyvinyl alcohol (preferably present in the range of 0-50 wt % of the agent where present), polyvinyl alcohol/vinyl acetate copolymers (preferably present in the range of 0-50 wt % of the agent where present), and polyvinylpyrrolidone/vinyl acetate copolymers (preferably present in the range of 0-50 wt % of the agent where present).

Preferably, at least one of the agents used in the method of the invention further includes one or more of the following components: (1) a bleach (with or without a bleach activator), (2) an enzyme or enzyme system (including any necessary stabilisers) and (3) at least one surfactant. Preferably first and second agents between them contain such components (1), (2) and (3), with (1) and (2) preferably being separated from each other, one in one agent, the other in the other agent.

In accordance with a second aspect of the present invention there is provided a method of treating a surface (preferably a textile surface in order to remove a stain thereon) employing the apparatus of the first aspect, comprising delivering from the device an agent onto a region of the surface delimited by the defining means.

In a preferred embodiment in which a gel patch is formed within the defining means, the method includes the step of removing the defining means from the surface, and thus lifting with it the gel patch.

Preferably, in the method of the present invention the user applies a first agent within the defining means to cover all or substantially all of a stain, and then, preferably within 120 seconds, more preferably within 90 seconds, even more preferably within 60 seconds, most preferably within 30 seconds, e.g. as soon as reasonably practical thereafter, applies a second agent to cover all or substantially all of the first agent, wherein these agents are the agents described hereinbefore, i.e. preferably a hydrogel-precursor agent and a cross-linking component comprising M²⁺ ions. Where a third agent is to be added, this is applied to cover all or substantially all of the second agent, within similar time periods to those noted above, with the overall application of all components being preferably within 180 secs, more preferably within 120 secs, most preferably within 90 secs.

Suitably the agents are then left until a removable patch has formed or substantially formed, which can then be removed by the user. Typically the patch takes between 10 secs and 10 mins to form after application of the final agent. It may in certain embodiments, particularly when surfactant is present, be indicated by the development of a white colour. Thus, preferably, the patch is removed at least 10 secs after application of the final component, more preferably at least 1 min after application of the final component, even more preferably at least 2 mins after application of the final component, yet even more preferably at least 5 mins after application of the final component, most preferably at least 10 mins after application of the final component.

The method of the present aspect of the invention may remove or substantially remove many if not all common stains found on textiles and the like, e.g. oxidisable stains, such as coffee, tea and wine stains, proteinaceous stains, together with ‘greasy’, stains such as those produced by lipstick and the like, grass stains etc.

Additionally the method may include the application of a compressive force to the material, against the surface.

When the material is in the form of a patch a subsequent step may be to peel the patch from the surface. In other embodiments, in particular when the material is a liquid, there may be steps of rubbing the material on the surface, and/or immersing the surface into a wash liquid.

However, the nature of the invention is such that these steps are optional. A yet further advantage of the method is its simplicity, even if these optional steps are employed. Simplicity in turn leads to increased likelihood of user compliance and thus effective treatment of surfaces.

The present invention will now be described, by way of example, with reference to the accompanying drawings in which:

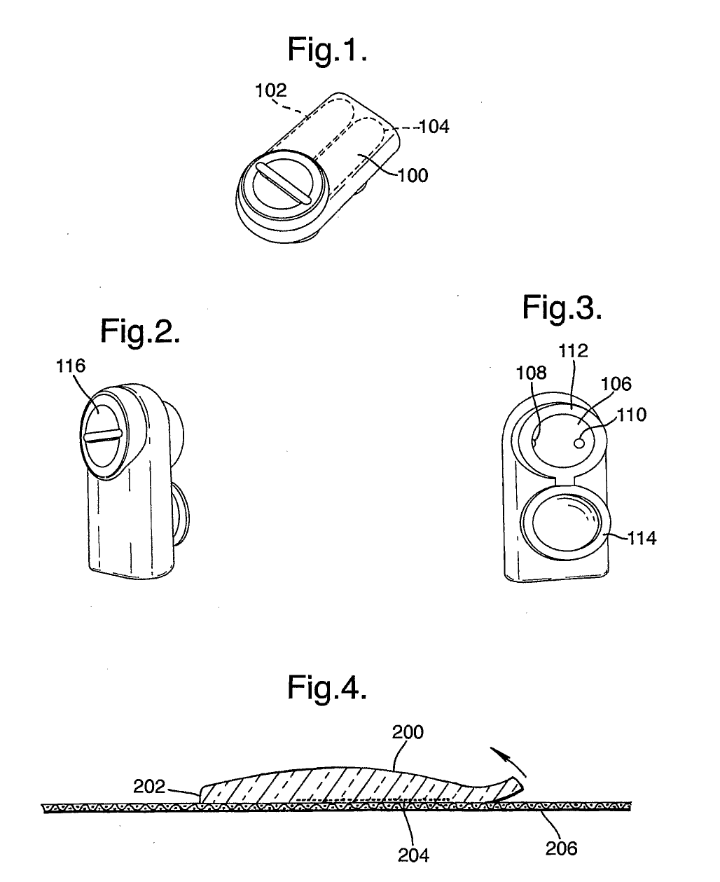

FIG. 1 shows a first embodiment of the invention in perspective view generally from above;

FIG. 2 shows the embodiment of FIG. 1 in a perspective view generally from one side;

FIG. 3 is a view of the rear face of the embodiment of FIG. 3;

FIG. 4 shows a patch formed by the embodiment of FIGS. 1-3;

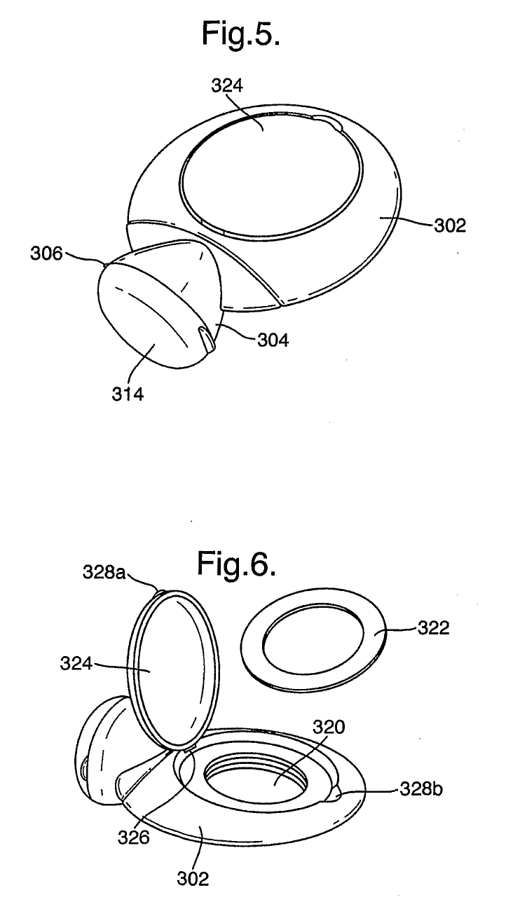

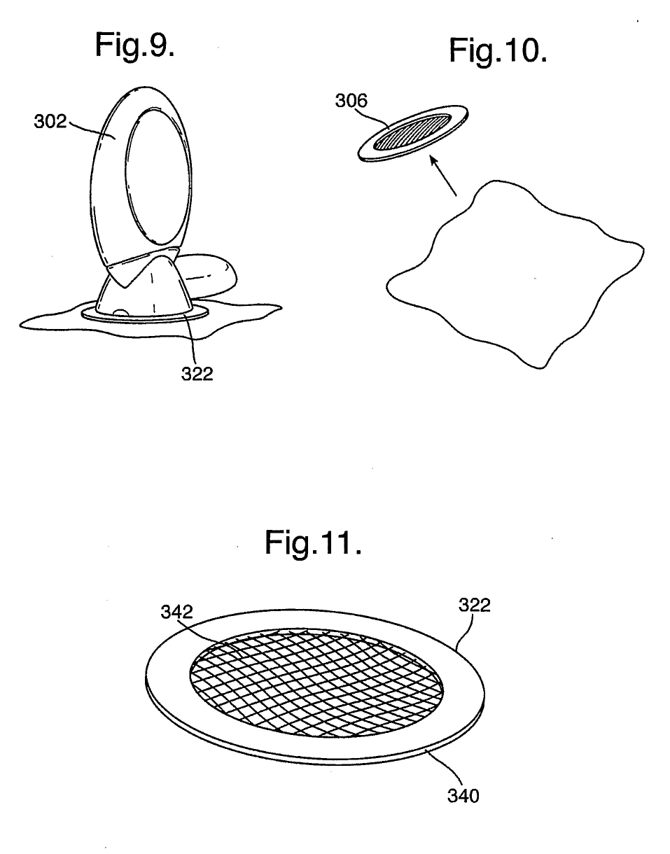

FIGS. 5-10 show a second embodiment of the invention in different stages of operation;

FIG. 11 shows an alternative embodiment of annular defining means;

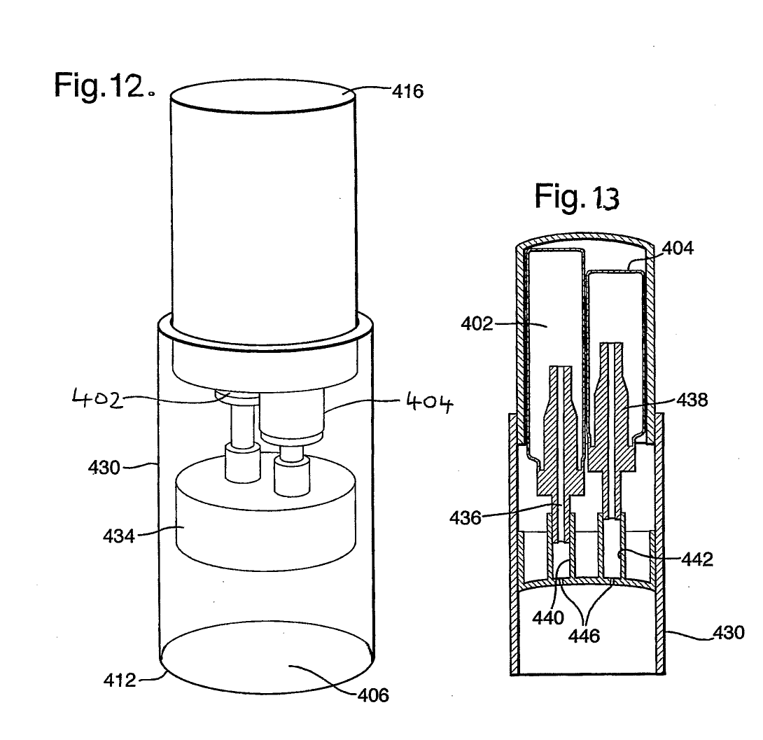

FIG. 12 shows a further embodiment of the invention in a perspective view;

FIG. 13 shows the embodiment of FIG. 12 in a lengthwise cross-sectional view; and

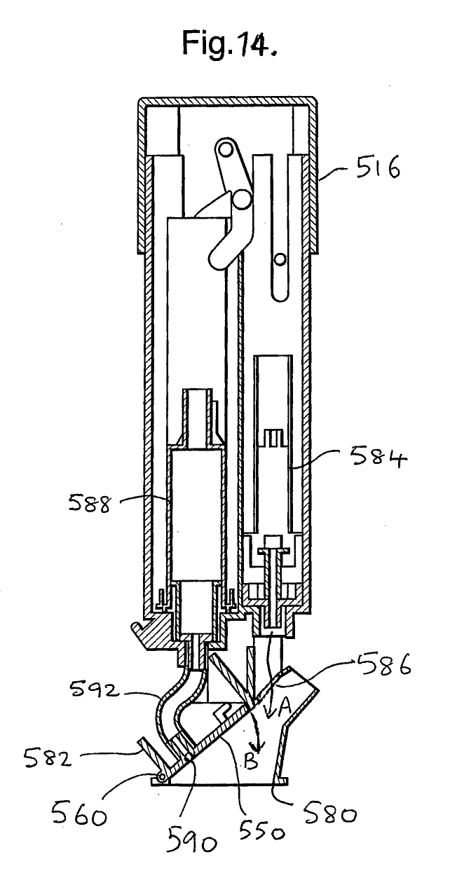

FIG. 14 is a lengthwise cross-sectional view of a yet further embodiment of the invention.

The first embodiment shown in FIGS. 1-3 has a body 100 containing two chambers, isolated from each other and containing a respective pressurised liquid. The first and second chambers are side-by-side within the body but cannot be seen in the figures shown as they are enclosed within a cover. Each chamber has its own outlet 108, 110 and these both feed into common outlet zone 106, bounded at its open end or terminus by a circular barrier wall or rim 112 which forms the defining means. This is normally closed by a closure cap 114. There is a rotary actuator 116 permitting delivery, in sequence, of the first and second liquids via the common outlet zone 106, both as sprays on to the limited area of surface within the defining means 112. The common outlet zone 106 bearing the defining means 112, and the actuator 116 are generally at one end of the body.

To effect removal of a stain from a fabric surface, closure cap 114 is removed and the device is positioned over the stain so that barrier wall 112 (the defining means) encloses the stain. The actuator 116 is then turned to deliver the first and then the second agent to the limited area of fabric provided within the defining means. The device is held in position for a period sufficient to allow the liquid agents to form a gel. The device is then removed to leave a gel patch 200 having the shape of the defining means—including a distinct side wall 202 as shown in FIG. 4. Stain 204 is absorbed into patch 200 which can be removed from fabric 206 by peeling. The provision of a distinct side wall 202 assists this process.

The second embodiment shown in FIGS. 5-10 has a generally disc-shaped body 302 standing on a widened base 304, which is generally in the shape of an inverted cup. The bottom of the base 304 defines the common outlet zone 306 of the device. The outlet is normally closed by a closure cap 314 connected to the barrier wall by a web of material 315. In FIGS. 7-9 the device is in its use configuration, and so the cap 314 is open, to expose the common outlet zone 306.

The disc-shaped body 302 includes a cavity 320 which houses a plurality of annular defining means 322. The cavity is accessible from the outside of body 302. The cavity has a cover 324 attached by a hinge 320 and closes by a snap-action fastening mechanism 328a, 328b.

Each annular defining means 322 is of thin, flexible plastics material.

The inside of body 302 houses two liquid agents in separate chambers, each of which has an outlet which feeds into the common outlet zone 306.

To operate the device, one of the annular defining means is removed from cavity 320 and placed on the fabric surface 330 to be treated, over a stain 333. Closure cap 314 is opened and a common outlet zone 306 of the device is placed over the defining means. Its rim rests on the annular wall of the annular defining means 322, slightly outside its inner circular edge.

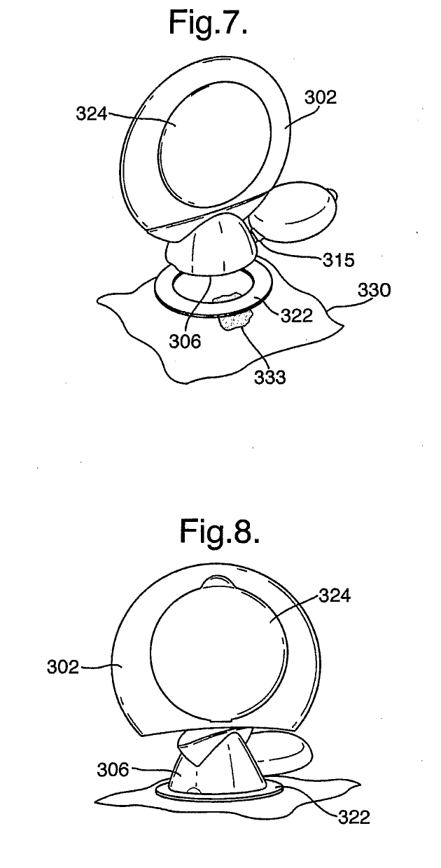

The main body 302 is rotatable on the base 304. When the main body has been turned by 60° from its normal position (see FIG. 8), the first liquid issues from the outlet onto the limited area of a fabric within the defining means. When turning continues, issuance of the first liquid stops, and then, issuance of the second liquid starts. This happens when the main body 302 has been turned from its starting position by about 120°. Turning continues, and when the main body has been turned by 180° no further liquid issues, and the device is in a rest position, ready to be used again.

At this point the device may be removed from the defining means. A gel patch forms within the annular defining means, and it extends a short distance onto the top face of the annular wall, to which it is adhered. After 10 minutes it may be removed from the fabric (FIG. 10). The use of the defining means to retain the patch aids this removal and allows the user to keep their hands free of chemical agents.

FIG. 11 shows an alternative annular defining means 322, in which the space within its wall 340 is filled with a mesh 342 formed by an open mesh formed by strands of a plastics filament material. The mesh provides structural support to the patch and reduces the risk of the patch tearing during removal. The wall 340 is of card material and is sufficiently flexible that it can be raised progressively from one place, to peel the defining means and patch away from the fabric in one movement, and in one piece.

In the embodiment shown in FIGS. 12 and 13 the device comprises an actuator in the form of a plunger 416, arranged to slide within a cylindrical barrel 430. The lower end of the cylindrical barrel defines a common circular outlet zone 406, bounded by the free edge 412 of the barrel. Zone 406 forms a defining means, delivering the treatment agents onto the required region. Also arranged to slide within the barrel 430, below the plunger 416, is a piston block 434. Mounted between the plunger 416 and the piston block 434 are two chambers 402, 404, respectively containing first and second liquids. Those chambers are in communication, respectively, with injector pistons 436, 438, the outlet ends of which are slidable within bores formed in upstanding formations 440, 442, in the piston block 434. The ends of those bores are perforated at 444 and 446 so that the first and second liquids can be expelled through the piston block into the common outlet zone. The base of the piston block, formed with the perforations 446, is somewhat concave or domed in shape, to accommodate the patch which will form.

In use, when the plunger 416 is depressed, it first depresses the first chamber 402 and first injector piston 436. The outlet end of injector piston 436 slides down the bore in the upstanding formation 440. In FIG. 13 the injector piston 436 is shown at an intermediate position, in the bore. When it reaches the end of the bore the chamber 402 is compressed, causing discharge of the first liquid, into the outlet zone. In the meantime the second chamber 404 and second injector piston 438 have been undergoing the same movement, but somewhat retarded, such that the second liquid is only expelled into the common outlet zone subsequently. During these operations the plunger is kept pressed down and the piston block is depressed, until it reaches the bottom of the barrel 430. This means that the gel that forms within the common outlet zone, on mixing of the first and second liquids, is subjected to compression by the piston block, against the surface being treated. This improves contact between the gel and the surface. The device is held in position with the pressing means still providing the compressive force, for a period sufficient to allow the liquid agents to form the gel. The device is then removed to leave the gel patch. A stain may be absorbed into the patch, which can be removed from fabric by peeling.

The embodiment of FIG. 14 differs from the embodiment of FIGS. 12 and 13 in two significant respects. Firstly, although the actuator includes a plunger 516 this is operated by a trigger lever (coming out from the plane of the drawing, and therefore not shown); and instead of a piston 434, the pressing means is in the form of a flap 550 pivotable about a hinge 560 located substantially at the level of the common outlet zone 580. The flap is operated by mainly pressing a second flap 582, integral with the first flap 550 but transverse to it (the two flaps forming an L-shape), and also pivotable about hinge 560.

In this embodiment the first liquid is contained within first chamber 584, from which the liquid is sprayed into the outlet zone via its own opening 586 along the arrow A shown in FIG. 3. The second liquid is contained within second chamber 588, from which the liquid passes into the outlet zone via its own opening 590 in the flap 550. To accommodate the movement of the flap 550 (this movement being denoted by arrow B) the conduit linking the second chamber 588 and the opening 590 is a flexible tube 592 sufficiently long not to hinder the movement of the flap 580.

In each of the above examples the first liquid may be a calcium chloride solution and the second liquid may be a hydrogel-precursor comprising a sodium alginate. The calcium chloride solution, acting as a cross-linking agent for the alginate, may be an aqueous solution of 15% CaCl₂.2H₂O, water-like in its flow properties.

The hydrogel-precursor comprised:

| | |
|---|---|
| Protanal ™ LF20 ™ (sodium alginate) | 3% |
| Glycerol | 8% |
| Bequest ™ 2066 (sequestrant) | 0.75% |
| Sodium lauryl sarcosinate | 4% |

pH adjusted to 8 with NaOH solution
Balance to 100% with deionised water

The viscosity of the hydrogel precursor is in the range from 7,000 to 8,000 mPa·s at a shear rate of 1 s⁻¹ at 25° C.

All figures given above are based on the weight of the particular component, on weight of the respective (first or second) liquid.

The liquids are typically applied to stained fabrics in the following sequence: CaCl₂ solution, followed by hydrogel-precursor; in some cases followed by CaCl₂ solution, using any of the devices described above. Each application is of a similar volume of liquid. Typically there will be an interval of some seconds between the application of liquids. The area is then typically left for 10 mins, after which time the presence of the sodium lauroyl sarcosinate surfactant ensures that the gel patch that has formed has a white colour. The patch is then removed manually by peeling.

However there may be other possibilities for obtaining useful cleaning benefits by means of interaction between first and second agents, including pH change, in situ generation of bleaching agents, foam or dye formation, fragrance release and heat generation.

1. Apparatus for treating a surface, the apparatus comprising a device for delivery of a treatment agent to the surface and defining means which is adapted for engagement with the surface, and which delimits the area of the surface which is thus treated.

2. Apparatus as claimed in claim 1, wherein the agent forms a gel within the defining means.

3. Apparatus as claimed in claim 1, wherein the device comprises a first chamber containing a first agent and a second chamber containing a second agent, wherein the defining means delimits the same area for both agents.

4. Apparatus as claimed in claim 3, wherein the device comprises actuator means to deliver the first agent and, subsequent to the commencement of delivery of the first agent, to deliver the second agent.

5. Apparatus as claimed in claim 4, wherein the actuator means is adapted to deliver the second agent only when the delivery of the agent liquid has ended.

6. Apparatus as claimed in claim 3, wherein the first and second agents interact to form a patch which is peelable from the surface.

7. Apparatus as claimed in claim 6, wherein one agent is a hydrogel-precursor and the other agent is a cross-linking agent therefor.

8. Apparatus as claimed in claim 7, wherein one agent is an aqueous solution of an alginate salt and the other agent is an aqueous solution of a calcium salt able to cross-link the alginate salt.

9. Apparatus as claimed in claim 3, wherein the device has a common outlet zone within which the first and second agents are discharged, wherein the defining means is provided by an endless rim at the terminus of the common outlet zone.

10. Apparatus as claimed in claim 1 wherein the defining means is provided as a part detachable or removable from the device or entirely separate from it.

11. Apparatus as claimed in claim 10, wherein the separate defining means has an opening surrounded by a boundary.

12. Apparatus as claimed in claim 10, wherein the device is provided with a storage means for the defining means.

13. Apparatus as claimed in claim 10 wherein the defining means comprises support elements extending across it, able to provide mechanical support for a gel within it.

14. Apparatus as claimed in claim 13, wherein the support elements are in the form of a mesh.

15. A method of treating a surface, the method employing apparatus as claimed in claim 1 and comprising delivering from the device an agent onto a region of the surface limited by the defining means.

16. A method as claimed in claim 15, wherein a gel patch is formed within the defining means, and the removal of the defining means from the surface lifts with it the gel patch.

17. A method as claimed in claim 15, wherein the surface is a textile surface bearing a stain, and the method is carried out to remove or reduce the stain.
